(19) United States
(12) Patent Application Publication
(10) Pub. No.: US 2026/0355850 A1
(43) Pub. Date: Nov. 12, 2026

(54) FRICTION STIR WELDING METHOD AND ASSOCIATED WELDING ASSEMBLY

(71) Applicant: Safran Nacelles, Gonfreville-l'Orcher (FR)

(72) Inventors: Xavier Holay, Moissy-Cramayel (FR); Eve-Anne Otero, Moissy-Cramayel (FR); Virginie Emmanuelle Anne-Marie Digeos, Moissy-Cramayel (FR)

(21) Appl. No.: 19/124,081

(22) PCT Filed: Oct. 27, 2023
(86) PCT No.: PCT/FR2023/051695

§ 371 Date: Apr. 24, 2025

(30) Foreign Application Priority Data
Oct. 28, 2022 (FR) FR2211252

(51) Int. Cl. B23K 20/12; B23K 103/10

(52) U.S. Cl. CPC B23K 20/1265; B23K 2103/10

(57) ABSTRACT

This method for friction stir welding a first piece on a second piece, the first piece being disposed on the second piece, comprises the following steps:
Machining a means for positioning and holding the first piece on the second piece on the first and second pieces the positioning and holding means machined comprising at least one projecting part and at least one groove intended to receive the at least one projecting part for positioning and holding the first piece on the second piece the at least one projecting part being machined on the first piece and the at least one groove being machined in the second piece,
Activating the positioning and holding means,
Friction stir welding a first welding zone of the first piece and a second welding zone of the second piece.

### TECHNICAL FIELD

The present invention relates to devices and methods for assembling by means of friction stir welding.

In particular, the invention relates to a method for welding two pieces by friction stir and a welding assembly associated therewith.

Generally speaking, the invention can be applied to any type of application requiring two components to be assembled by friction stir welding.

### PRIOR ART

In industry, and in particular in the aeronautics industry, it is common to have to assemble several elements together. This can involve, for example, assembling a stiffener to a structural panel of an aircraft in order to rigidify said structural panel.

Among the different assembling methods, friction stir welding is an assembling method that makes it possible, using a welding tooling comprising a rotating tip of less than five millimetres in diameter, to stir materials of the elements to be assembled and thus create a weld. Friction stir welding is particularly suitable for aluminium alloys.

To weld two pieces together, the pieces have to be positioned relative to each other and held in position during welding. For this, one of the existing solutions is illustrated in FIG. 1, and consists in positioning and holding the pieces by a pin system. More particularly, with reference to FIG. 1, a welding assembly 1 comprises a first piece 2 and a second piece 3. Pre-drilled holes are made in the pieces 2 and 3, into which pins 4 are inserted. By virtue of the pins 4, the first piece 2 is positioned and held on the second piece 3, making it possible to perform friction stir welding using a welding tooling 5. In FIG. 1, welding is in progress, and a weld bead 6 is made where the tooling 5 has already passed.

However, there are many drawbacks to this solution. First of all, the pin and pre-drilled hole system is of large overall size, and harmful to the welding trajectories and the machine environment. In addition, this solution blocks passage of the welding tooling 5, which cannot be used too close to the pins 4. This results in a limitation of the weld bead 6 in the vicinity of the pins 4. In general, it is not possible, by the conventional friction stir welding method, to achieve a continuous trajectory of the weld bead 6 between the two pieces to be welded. Hence, the pins have to be removed after the welding is made, and then leave the pre-drilled holes free, which have to be plugged by standard riveting to ensure sealing and aerodynamics. Finally, due to a slight displacement of the two pieces 2 and 3 relative to one another during welding, the pre-drilled holes present and aligned on the two pieces 2 and 3 may be offset, which causes the pins 4 to be tightened and blocked in the pre-drilled holes.

### SUMMARY OF THE INVENTION

The purpose of the present invention is therefore to overcome the aforementioned drawbacks.

One object of the present invention is therefore a method for friction stir welding a first piece on a second piece, the first piece being disposed on the second piece, comprising the following steps:
Machining a means for positioning and holding the first piece on the second piece on the first and second pieces, the machined positioning and holding means comprising at least one projecting part and at least one groove intended to receive the at least one projecting part for positioning and holding the first piece on the second piece, the at least one projecting part being machined on the first piece and the at least one groove being machined in the second piece,
Activating the positioning and holding means,
friction stir welding a first welding zone of the first piece and a second welding zone of the second piece.

Preferably, the step of activating the positioning means comprises assembling the at least one projecting part with the at least one groove intended to receive the at least one projecting part.

Advantageously, the at least one projecting part is machined on a lower surface of the first piece, and the at least one groove is machined in an upper surface of the second piece.

Preferably, the at least one projecting part is machined in an aluminium alloy. Advantageously, the at least one projecting part is machined in the material of the first welding zone.

Advantageously, the at least one projecting part is machined on the first welding zone of the first piece and the at least one groove is machined in a portion of the second welding zone intended to be in contact with the at least one projecting part.

In one embodiment, the at least one groove is machined in a portion of the second welding zone intended to be in contact with the first welding zone.

In this embodiment, during the welding step, at least one portion of the positioning and holding means is friction stir welded at the first and second welding zones.

In one embodiment, the method comprises a step of applying an insulating element into the at least one groove, prior to the step of activating the positioning and holding means.

Preferably, the insulating element is sealant.

Another object of the invention is a weld obtained from the implementation of a friction stir welding method as defined previously on a welding assembly comprising a first piece disposed on a second piece.

### BRIEF DESCRIPTION OF THE DRAWINGS

Other purposes, characteristics and advantages will become apparent upon reading the following description, given merely as a non-limiting example, and made with reference to the appended drawings, wherein:

FIG. 1 illustrates an example of implementation of a known friction welding method of prior art on a welding assembly;

FIG. 2 illustrates an initial welding assembly in transverse cross-section view before implementing the method according to the invention;

FIG. 3 illustrates an example of a friction stir welding method according to the present disclosure;

FIG. 4 illustrates a first example of implementation of the method of FIG. 3 in accordance with the present disclosure on the welding assembly of FIG. 2, illustrated in a longitudinal cross-section view;

FIG. 5 illustrates the example of FIG. 4 in a cross-section view;

FIG. 6 illustrates the example of FIG. 4 in a top view;

FIG. 7 illustrates a second example of implementation of the method of FIG. 3 in accordance with the present disclosure on the welding assembly of FIG. 2, illustrated in a transverse cross-section view;

FIG. 8 illustrates the example of FIG. 7 in a top view;

FIG. 9 illustrates a third example of implementation of the method of FIG. 3 in accordance with the present disclosure on the welding assembly of FIG. 2, illustrated in a transverse cross-section view.

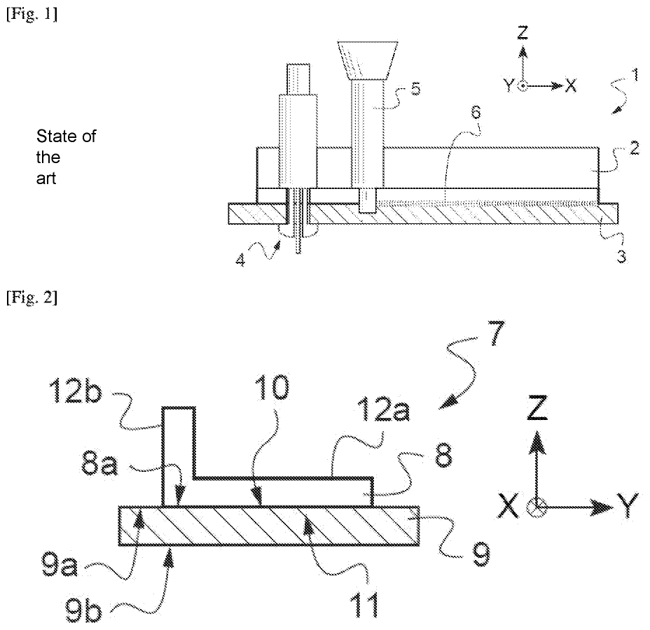

### DETAILED DESCRIPTION

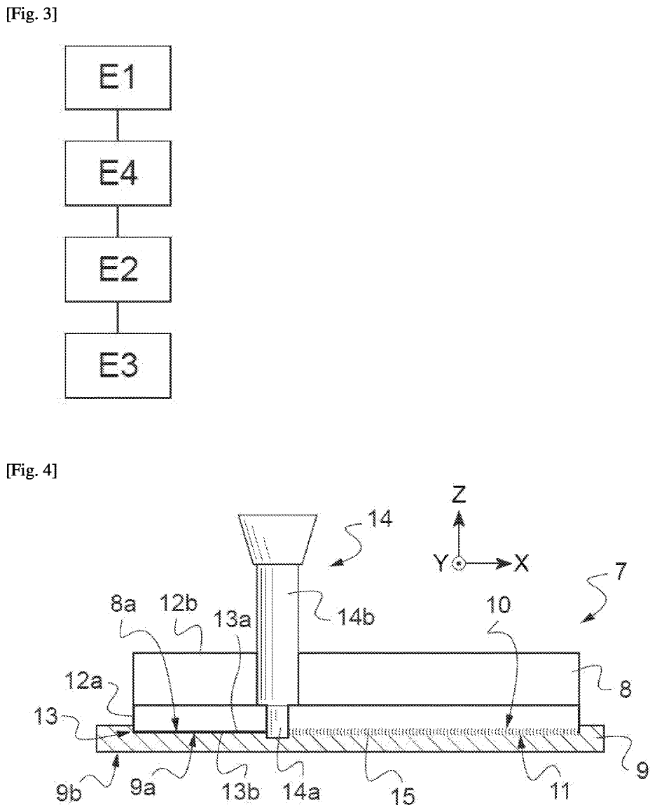

An initial welding assembly 7 has been schematically represented in FIG. 2 before the application of a friction stir welding method according to the invention represented in FIG. 3. The welding assembly 7 comprises a first piece 8 and a second piece 9, schematically illustrated in a cross-section view.

For the purposes of the description, reference is made to a direct orthonormal reference frame, in which the X axis denotes the longitudinal direction of the welding assembly 7, the Y axis denotes the direction along the width of the welding assembly 7, and the Z axis denotes the vertical, upwardly oriented, direction.

FIG. 2 therefore illustrates a transverse cross-section view along a plane parallel to the Y axis of the welding assembly 7.

For example, the first piece 8 is a stiffener and the second piece 9 is an aircraft structural panel.

The first piece 8 and the second piece 9 are intended to be friction stir welded together in transparency, i.e. on top of one another. Thus, the first piece 8 comprises a lower surface 8a preferably entirely resting on an upper surface 9a of the second piece 9.

More precisely, the first piece 8 comprises a first welding zone 10 and the second piece 9 comprises a second welding zone 11, which define respective parts of the pieces 8 and 9 intended to be mixed together during friction stir welding.

The first welding zone 10 thus comprises at least one portion of the lower surface 8a and the second welding zone 11 comprises at least one portion of the upper surface 9a which is intended to be in contact with the first welding zone 10. Thus, the first welding zone 10 and the second welding zone 11 are in fact positioned in contact with one another.

By way of non-limiting example in the scope of the present disclosure, the first piece 8 illustrated in FIG. 2 is an L-shaped stiffener, comprising a base 12a and a shoulder 12b.

The first piece 8 and the second piece 9 are made of materials adapted to friction stir welding. In particular, the first piece 8 and the second piece 9 are made from aluminium alloys, possibly different from one another.

FIG. 3 illustrates a method for friction stir welding the first piece 8 on the second piece 9 able to be implemented on the welding assembly 7. The method steps are described below.

In a first step E1, a positioning and holding means is machined on the first and second pieces 8 and 9, the positioning and holding means comprising at least one projecting part and at least one groove intended to receive the projecting part, the at least one projecting part being machined on the lower surface 8a of the first piece 8, and the at least one groove being machined in the upper surface 9a of the second piece 9.

Once the holding and positioning means has been machined, a step E2 comprises installing the first piece 8 on the second piece 9, and activating the positioning and holding means to ensure proper positioning and holding of the first piece 8 on the second piece 9. Activating the positioning and holding means consists in inserting the at least one projecting part into the at least one corresponding groove. In this way, the first piece 8 is correctly positioned and held on the second piece 9, allowing in a third step E3 to perform friction stir welding of the first welding zone 10 and the second welding zone 11.

Optionally, the method comprises a step E4 between the first and second steps E1 and E2, in which an insulating element is applied into the at least one groove.

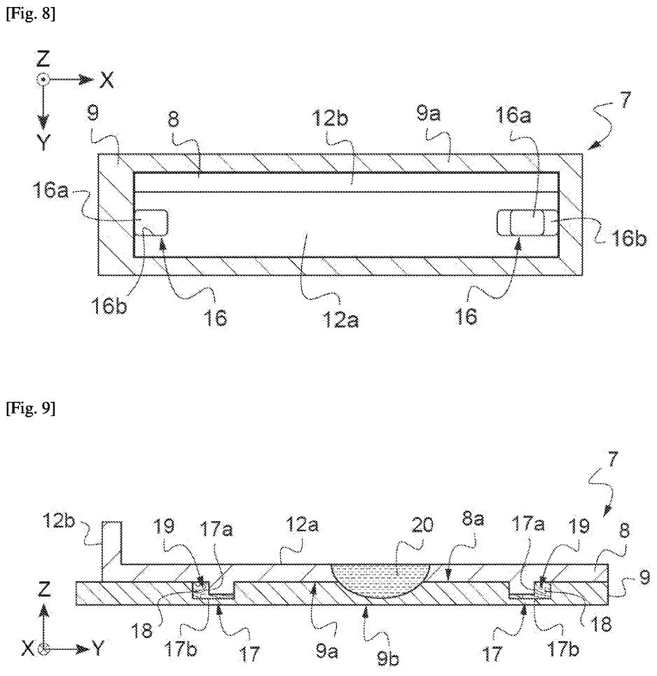

Different examples of implementation of this method of FIG. 3 on the initial welding assembly 7 of FIG. 2 will be described in the following. In particular, FIGS. 4, 5 and 6 illustrate a first example of implementation of the method of FIG. 3, FIGS. 7 and 8 illustrate a second example and FIG. 9 illustrates a third example.

Only the third example comprises the optional step E4.

The first example of implementation of the method of FIG. 3 on the welding assembly 7 of FIG. 2 is illustrated in FIGS. 4, 5 and 6.

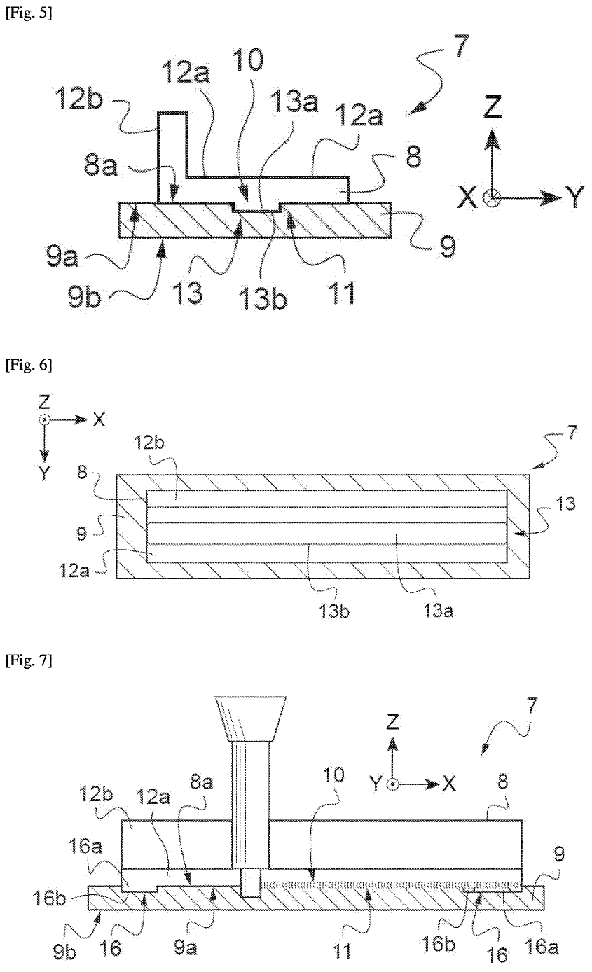

In particular, FIG. 4 illustrates a longitudinal cross-section view in a plane parallel to the X axis of the welding assembly 7 during step E3 of the first example of implementation of the welding method of FIG. 3, FIG. 5 illustrates a cross-section view in a plane parallel to the Y axis of the welding assembly 7 of FIG. 4, and FIG. 6 illustrates a top view in a plane perpendicular to the Z axis of the welding assembly 7 at the end of step E2 of the first example of implementation of the welding method of FIG. 3.

During the first step E1 of this first example of implementation of the method of FIG. 3, a positioning and holding means 13 is machined on the first and second pieces 8 and 9. More precisely, the positioning and holding means 13 comprises at least one projecting part 13a machined on the first piece 8 and at least one corresponding groove 13b provided on the second piece 9 and intended to receive and cooperate with the projecting part 13a. The projecting part 13a can thus be referred to as a male portion of the first piece 8 cooperating with the groove 13b of the second piece 9 which can be referred to as a female portion.

The projecting part 13a is machined on the lower surface 8a of the first piece 8, and more particularly on the portion of the lower surface 8a included in the first welding zone 10 of the first piece 8. The projecting part therefore extends downwardly when the lower surface 8a is disposed on the upper surface 9a.

Correspondingly, the groove 13b corresponding to said projecting part 13a is machined in the upper surface 9a of the second piece 9, and more particularly in the portion of the upper surface 9a included in the second welding zone 11 and which is intended to be in contact with the first welding zone 10. This portion of the upper surface 9a on which the groove 13b is machined is also intended to be in contact with the projecting part 13a.

In FIG. 6 illustrating a top view of the welding assembly 7, the base 12a is represented in transparency so as to reveal the projecting part 13a and the groove 13b.

In this first example represented in FIGS. 4, 5 and 6, the projecting part 13a extends over the entire length along the X axis of the lower surface 8a of the first piece 8. Similarly, the groove 13b is correspondingly machined over the entire length along the X axis of the upper surface 9a of the second piece 9 in contact with the lower surface 8a. The dimension of the projecting part 13a along the Y axis is less than 30% of the dimension along the Y axis of the first piece 8. The groove 13b also extends along the Y axis over a distance of less than 30% of the dimension along the Y axis of the first piece 8, this distance being nevertheless a few millimetres greater than the dimension along the Y axis of the projecting part 13a, such that the groove 13b is configured to receive and enclose the projecting part 13a.

Thus, the projecting part 13a and the groove 13b are properly configured to cooperate such that the groove is able to receive the projecting part 13a when the lower surface 8a of the first piece 8 is correctly disposed on the upper surface 9a of the second piece 9.

The holding and positioning means 13 is machined in an aluminium alloy, possibly identical to the alloy used to manufacture one of the welding zones 10 and 11. For example, the projecting part 13a is machined in the same material as the first welding zone 10.

The holding and positioning means 13 is dimensioned to be included in the first and second welding zones 10 and 11. Thus, the holding and positioning means 13 is configured to be friction stir welded at least partially to the first and second pieces 8 and 9, and therefore to the first and second welding zones 10 and 11.

During step E2, the first piece 8 is positioned on the piece 9 and the positioning and holding means 13 is activated. More precisely, activating the positioning and holding means 13 comprises a phase of assembling the projecting part 13a with the corresponding groove 13b. The projecting part 13a is thus inserted into the corresponding groove 13b. In this way, the first piece 8 is correctly positioned and held on the second piece 9.

In the third step E3, friction stir welding of the first welding zone 10 and the second welding zone 11 is performed.

In particular, welding step E3 is carried out using a friction stir welding tooling 14, and consists of a first phase of setting up the friction stir welding tooling for welding the first piece 8 on the second piece 9. Setting up consists in positioning the assembly 7 of the two pieces 8 and 9 assembled and secured by the positioning and holding means 13 on a welding jig of the welding tooling intended to support the lower surface 9b of the second piece 9.

The friction stir welding tooling 14 comprises a rotary tip 14a for friction stir welding and a shoulder 14b bearing the tip 14a at one of its ends. The thickness of the tip 14a determines the size of the weld zones 10 and 11, and therefore the dimensions of the projecting part 13a perpendicularly to the surface 8a.

As part of a second phase of step E3, the welding tooling 14 is inserted into the first piece 8 up to the welding zones 10 and 11, as illustrated in FIG. 4. The welding tooling 14 is inserted so as to be in contact with the positioning means 13 and the welding zones 10 and 11. The third phase of step E3, which is welding, then begins, and a weld bead 15 is formed in the welding zones 10 and 11 as the tooling 14 is advanced and the welding zones 10 and 11 are heated locally because of the action of the rotary tip 14a. The direction of advance of the welding tooling 14 in FIG. 4 is from right to left. In the first implementation example, the positioning and holding means 13 is thus at least partially welded to the first and second pieces 8 and 9.

The welding trajectory followed by the welding tooling 14 then follows the positioning means 13, as illustrated in FIG. 2, and is not limited by a pin. The positioning and welding means 13 is fully welded to the first and second welding zones 10 and 11 of the pieces 8 and 9 at the end of step E3.

It is therefore understood that the holding and positioning means 13 has the function of holding the first and second pieces 8 and 9 together, which makes it possible to dispense with the use of pins, and consequently, to limit the pre-drilled holes and the subsequent use of rivets or other solutions of plugging these drilled holes. The holding and positioning means 13 thus eliminates obstacles to obtaining a continuous weld bead 15. More generally, it is thus possible to use the welding tooling 14 in all the zones required between both pieces without problems of accessibility and overall size. This eliminates the need to adapt the weld bead trajectory or stop the bead before the pin zones. In addition, no elements need to be removed at the end of welding, and no elements such as riveting need to be added.

The second example of implementation of the method of FIG. 3 on the welding assembly 7 of FIG. 2 is illustrated in FIGS. 7 and 8. More precisely, as in FIG. 4, FIG. 7 illustrates a longitudinal cross-section view in a plane parallel to the X axis of the welding assembly 7 during step E3 of the second example of implementation of the welding method of FIG. 3. Similarly, as in FIG. 6, FIG. 8 illustrates a top view in a plane perpendicular to the Z axis of the welding assembly 7 at the end of step E2 of the second example of implementation of the welding method of FIG. 3.

As for the first example, a positioning and holding means 16 is machined during step E1 on the first and second pieces 8 and 9.

The positioning means 16 differs from the first example in that it comprises several projecting parts 16a and several corresponding grooves 16b intended to each receive one of the projecting parts 16a for positioning and holding the first piece 8 on the second piece 9. In the example illustrated in FIGS. 7 and 8, two projecting parts 16a are machined on the portion of the lower surface 8a included in the first welding zone 10, and two grooves 16b are provided in the portion of the upper surface 9a included in the second welding zone 11 intended to be in contact with the projecting parts 16a.

The positioning means 16 also differs from the first example in that the corresponding projecting parts 16a and grooves 16b do not have the same dimension along X axis. Indeed, both projecting parts 16a, as well as both grooves 16b, have a dimension along X axis between 5% and 15% of the dimension along X axis of the first piece 8. The dimensions along Y axis of the projecting parts 16a of the grooves 16b are the same as in the first example.

In addition, one of the two groove parts 16b has a dimension along X axis that is at least 50% greater than the dimension along X axis of the other groove, such that the longest groove along X axis is configured to allow an additional degree of freedom of movement of the projecting part 16a it receives during step E2, in order to avoid both pieces 8 and 9 being hyperstatic. In the example illustrated in FIGS. 7 and 8, the groove 16b allowing an additional degree of freedom is the right-hand groove.

Steps E2 and E3 are carried out in the same way as for the first example of implementation.

The third example of implementation of the method of FIG. 3 on the welding assembly 7 of FIG. 2 is illustrated in FIG. 9. More precisely, as in FIG. 5, FIG. 9 illustrates a cross-section view in a plane parallel to Y axis of the welding assembly 7 at the end of step E3 of the third example of implementation of the welding method of FIG. 3.

As for the first two examples, a positioning and holding means 17 is machined during step E1 on the first and second pieces 8 and 9. The positioning means 17 comprises two projecting parts 17a and two grooves 17b configured to receive and enclose the projecting parts 17a.

The dimensions along X axis and along Y axis of the projecting parts 17a and the grooves 17b are identical to the dimensions along these same axes of the projecting part 13a and the groove 13b of the first example of implementation.

The two projecting parts 17a are machined in parallel on the lower surface 8a of the first piece 8, outside and on either side of the first welding zone 10. Similarly, the two grooves 17b are machined in parallel on the upper surface 9a of the second piece 9, outside and on either side of the second welding zone 11. Thus, the positioning and holding means 17 is not intended to be welded during step E3, unlike the first two examples.

The third example is the only example described in which the optional step E4 is performed. Thus, at the end of step E1, an insulating element 18 is applied in the grooves 17b. The insulating element is, for example, sealant.

During the step E2 of activating the positioning and holding means 17, inserting the projecting parts 17a into the grooves 17b causes the insulating element 18 to reflux into a free space 19 between the walls of the grooves 17b and the walls of the projecting parts 17a, this free space resulting from the difference in dimension of a few millimetres between the grooves 17b and the projecting parts 17a. In this way, the insulating element 18 makes it possible to seal the positioning and holding means 17 by filling the free space.

In the last step E3, the first welding zone 10 is friction stir welded to the second welding zone 11, so that the welding trajectory is drawn between the two projecting parts 17a inserted into the grooves 17b. In this way, the positioning and holding means 17 is not welded to the first and second pieces, unlike the first two examples described. A weld bead 20 is therefore formed between the two projecting parts 17a inserted into the grooves 17b during step E3.

Step E4 is optional and makes it possible to overcome the cases, as illustrated in the first two examples described, where the welding trajectory does not make it possible to weld the entire positioning and holding means machined in step E1 to the welding zones 10 and 11. Indeed, when the positioning and holding means is not fully welded to the welding zones 10 and 11, the difference between the dimensions of the projecting parts and the grooves causes the presence of free spaces between the walls of the projecting parts and the grooves, resulting in a lack of sealing of the assembly welded.

Conversely, when the positioning and holding means machined in step E1 is fully welded with the welding zones 10 and 11 in step E3, mixing of the materials friction stir welded makes it possible to fill the initial free space and seal the assembly welded.

1. A friction stir welding method for a first piece on a second piece, the first piece being disposed on the second piece the method comprising the following steps:
Machining a means of positioning and holding the first piece on the second piece on the first and second pieces, the positioning and holding means machined comprising at least one projecting part and at least one groove intended to receive the at least one projecting part for positioning and holding the first piece on the second piece, the at least one projecting part being machined on the first piece and the at least one groove being machined in the second piece;
Activating the positioning and holding means; and
Friction stir welding a first welding zone of the first piece and a second welding zone of the second piece.

2. The welding method of claim 1, wherein the step of activating the positioning and holding means comprises assembling the at least one projecting part with the at least one groove intended to receive the at least one projecting part.

3. The welding method according to claim 1, wherein the at least one projecting part is machined on a lower surface of the first piece and the at least one groove is machined in an upper surface of the second piece.

4. The welding method according to claim 1, wherein the at least one projecting part is machined in an aluminium alloy.

5. The welding method according to claim 1, wherein the at least one projecting part is machined in the material of the first welding zone.

6. The welding method according to claim 1, wherein the at least one projecting part is machined on the first welding zone of the first piece and the at least one groove is machined in a portion of the second welding zone intended to be in contact with the at least one projecting part.

7. The welding method according to claim 1, wherein the at least one groove is machined in a portion of the second welding zone intended to be in contact with the first welding zone.

8. The welding method according to claim 1, wherein during the welding step, at least one portion of the positioning and holding means is friction stir welded at the first and second welding zones.

9. The welding method according to claim 1, comprising a step of applying an insulating element into the at least one groove, prior to the step of activating the positioning and holding means.

10. The method according to claim 8, wherein the insulating element is sealant.

11. A weld obtained from implementing a friction stir welding method according to claim 1 on a welding assembly comprising a first piece disposed on a second piece.
